(19) United States
(12) Patent Application Publication
(10) Pub. No.: US 2015/0323441 A1
(43) Pub. Date: Nov. 12, 2015

(54) High Pressure Utilization of Quartz Crystal Microbalance

(71) Applicants: Jason W. Lachance, Magnolia, TX (US); Jeffrey D. Spitzenberger, Richmond, TX (US)

(72) Inventors: Jason W. Lachance, Magnolia, TX (US); Jeffrey D. Spitzenberger, Richmond, TX (US)

(21) Appl. No.: 14/691,354

(22) Filed: Apr. 20, 2015

Related U.S. Application Data
(60) Provisional application No. 61/989,850, filed on May 7, 2014.

(51) Int. Cl. G01N 11/16; G01N 9/00

(52) U.S. Cl. CPC G01N 11/16; G01N 9/002

(57) ABSTRACT

A QCM sensor apparatus comprising a QCM mounting insert having a first opening, a second opening, and a barrier fluid chamber disposed between the first opening and the second opening, and a QCM wafer sealably coupled to the second opening, wherein the QCM wafer has an electrode contact exposed to the barrier fluid chamber and a sensitive layer that is not exposed to the barrier fluid chamber.

### CROSS REFERENCE TO RELATED APPLICATIONS

This application claims the priority benefit of U.S. patent application No. 61/989,850 filed May 7, 2014 entitled HIGH PRESSURE UTILIZATION OF QUARTZ CRYSTAL MICROBALANCE, the entirety of which is incorporated by reference herein.

### FIELD

The invention relates to certain techniques, embodiments, and implementations related to a sensor for measuring properties of a fluid at a high pressure.

### BACKGROUND

In industrial environments, working fluid analysis constitutes an important role in preventive maintenance programs. One approach to a monitoring a fluid's quality is to measure the properties of the fluid via an electrochemical impedance technique. Presently there are a number of different types of instruments and methods for taking such measurements. For example, quartz crystal microbalances (QCMs) are commercially available for measuring certain liquid properties.

The QCM technique is based upon the piezoelectric effect, which is a crystal oscillation brought about by an alternating electric field applied across opposite sides of a quartz crystal. In general, a quartz crystal's oscillation frequency shifts if a mass is bound to the crystal surface. The mass required to create a detectable shift is only about 1 nanogram, illustrating the extreme mass sensitivity of the QCM technique. Appropriate oscillator circuits connected to the surface electrodes can overcome energy losses and stabilize the mechanical oscillation at the resonance frequency. The cut-angle with respect to crystal orientation (“AT-cut”) determines the mode of oscillation. For example, AT-cut quartz crystals may have a cut angle of 35 °10′ with respect to the optical axis. Such crystals perform shear displacements perpendicular to the resonator surface.

QCMs have been used at atmospheric pressure in gaseous environments and in liquid environments. Frequency measurements may be made to high precision, permitting mass density measurement down to a low level. In addition to measuring the frequency, dissipation may also be measured. Dissipation is a parameter quantifying the damping in the system, and is related to the sample's viscoelastic properties. However, QCM usage in high pressure fluid environments has remained problematic due, in part, to the brittleness of QCMs and the various pressures to which QCMs may be exposed. Consequently, there exists a need for techniques to permit usage of QCMs in high pressure fluid environments.

### SUMMARY

One embodiment includes a QCM sensor apparatus comprising a QCM mounting insert having a first opening, a second opening, and a barrier fluid chamber disposed between the first opening and the second opening, and a QCM wafer sealably coupled to the second opening, wherein the QCM wafer has an electrode contact exposed to the barrier fluid chamber and a sensitive layer that is not exposed to the barrier fluid chamber.

Another embodiment includes a QCM sensor system comprising a QCM mounting insert comprising a first opening, a second opening, a barrier fluid chamber disposed between the first opening and the second opening, and a barrier fluid port configured to receive a barrier fluid and direct the barrier fluid to the barrier fluid chamber, a QCM wafer sealably coupled to the second opening of the QCM mounting insert, comprising a sensitive layer on a first face, and an electrode contact layer on a second face, a QCM sensor housing comprising an annulus configured to receive the QCM mounting insert, a working fluid inlet, a working fluid outlet, and a working fluid chamber, and a pressure leg coupled to the barrier fluid port and configured to transfer a pressure to the barrier fluid chamber, wherein the QCM mounting insert is configured to expose at least part of the first face of the QCM wafer to the working fluid chamber and expose at least part of the second face of the QCM wafer to the barrier fluid chamber when the QCM mounting insert is received in the annulus of the QCM sensor housing.

Still another embodiment includes a method of measuring a deposit on a quartz crystal microbalance (QCM) sensor, comprising placing in service an apparatus comprising a QCM wafer coupled to a QCM mounting insert, wherein the QCM mounting insert comprises a first opening, a second opening, and a barrier fluid chamber positioned between the first opening and the second opening, wherein the QCM wafer has a first face having a sensitive layer and a second face having an electrode contact, wherein the QCM wafer is sealably coupled to the second opening such that at least part of the second face is exposed to the barrier fluid chamber, and wherein the QCM mounting insert is received in an annulus of a QCM housing, wherein the QCM housing comprises a working fluid inlet, a working fluid outlet, and a working fluid chamber, applying a first pressure on the first face of the QCM wafer using a barrier fluid and applying a second pressure on the second face of the QCM wafer using a working fluid, wherein the first pressure and the second pressure are substantially equal, flowing the working fluid from the working fluid inlet to the working fluid outlet such that the working fluid is passed across the first face of the QCM wafer in the working fluid chamber, wherein flowing the working fluid deposits a substance on the first face of the QCM wafer, substantially stopping the flow of the working fluid across the first face of the QCM wafer in the working fluid chamber; and measuring a resonance frequency of the QCM wafer.

### BRIEF DESCRIPTION OF THE DRAWINGS

The advantages of the present techniques are better understood by referring to the following detailed description and the attached drawings, in which:

FIG. 1A is a schematic illustration of a QCM wafer.

FIG. 1B is a perspective view of a QCM wafer.

FIG. 2 is an exploded perspective view of a QCM sensor system.

FIG. 3 is a line diagram of a QCM sensor system in situ.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described herein, but rather, include all alternatives, modifications, and equivalents falling within the true spirit and scope of the appended claims.

At the outset, for ease of reference, certain terms used in this application and their meanings as used in this context are set forth. To the extent a term used herein is not defined herein, it should be given the broadest definition persons in the pertinent art have given that term as reflected in at least one printed publication or issued patent. Further, the present techniques are not limited by the usage of the terms shown herein, as all equivalents, synonyms, new developments, and terms or techniques that serve the same or a similar purpose are considered to be within the scope of the present claims.

As used herein, the term “about” when used in reference to a quantity or amount of a material, or a specific characteristic thereof, refers to an amount±10% of the reference value, unless otherwise noted.

As used herein, the term “barrier fluid” expressly includes electrically inert and/or benign fluids, e.g., mineral oil, fluorocarbon-based fluids, liquid nitrogen, liquid helium, etc. The term “barrier fluid” may additionally include any non-corrosive fluid with respect to a protective coating, layer, or other barrier used for ensuring electrical connectivity between a QCM and an electrical connection. The term “barrier fluid” may further include any “clean” or substantially contaminant-free and/or deposit-free fluid.

As used herein, the term “fluid” may refer to a continuous, amorphous substance that can flow, has no fixed shape, and offers little resistance to an external stress. Unless otherwise noted, the term “fluid” may be used interchangeably with the term “liquid” for purposes of this disclosure.

As used herein, the term “pressure” is taken to mean the force exerted per unit area by the gas on the walls of the volume. Pressure can be shown as pounds per square inch (psi). “Absolute pressure” (psia) refers to the sum of the atmospheric pressure (14.7 psia at standard conditions) plus the gage pressure (psig). “Gauge pressure” (psig) refers to the pressure measured by a gauge, which indicates only the pressure exceeding the local atmospheric pressure (i.e., a gauge pressure of 0 psig corresponds to an absolute pressure of 14.7 psia).

As used herein, the term “substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context as understood by those of skill in the relevant art.

As used herein, the term “working fluid” expressly includes hydrocarbons, for example, natural gas (e.g., liquefied natural gas (LNG)), kerosene, gasoline, or any number of other natural or synthetic hydrocarbons such as CH₄, C₂H₂, C₂H₄, C₂H₆, C₃ isomers, C₄ isomers, benzene, base stock oils, natural crude oils, and the like, as well as composite fluids comprising a mixture of any of the foregoing with at least one additional fluid and/or component, e.g., nitrogen, sulfur, oxygen, metals, or any number of other elements. The term “working fluid” may further include any fluid for which QCM monitoring may be desirable, wherein the fluid possesses certain electrically conductive or fouling characteristics so as to make problematic the exposure of the QCM's electrical contacts to the fluid.

This disclosure includes techniques for using a QCM in a high pressure environment. QCM wafers are susceptible to cracking, breaking, or other fracturing when exposed to comparatively slight differential pressures. Further, many working fluids for which QCM measurements are desirable are not suitable for exposing to the non-sensing side of the QCM. For example, corrosive or electrically conductive fluids may not be suitably exposed to the electrical connections of the QCM, and fluids with fouling characteristics may be problematic for similar or other reasons. The disclosed techniques include minimizing and/or keeping substantially constant the differential pressure seen by QCM wafers by creating and pressurizing a rear chamber, understood as a volume or special region for fluid accumulation, on the non-sensing side of the QCM. The rear chamber on the non-sensing side of the QCM may be pressurized using a suitable fluid. For example, substantially debris/contaminant-free fluids (“clean” fluids) and/or electrically benign fluids may be housed

The QCMs described herein can be liquid phase QCM systems. Such systems may consist of an oscillator circuit and a slice of AT-cut piezoelectric quartz crystal. Metal film electrodes may be deposited onto both sides of the quartz crystal, one side being a working electrode in an electrochemical cell. The metal electrodes may produce an alternating electric field that drives the quartz crystal to oscillate at a characteristic constant frequency, determined by the crystal mass. An increase in any form of bound elastic mass on the quartz crystal surface will cause the crystal to change its oscillation frequency according to the Sauerbrey equation, which may be used to quantify the amount of mass added to the crystal surface. For energy dissipating bound masses on the crystal surface, the change in crystal frequency reflects two attributes: the bound mass magnitude and the viscoelastic properties of the bound mass.

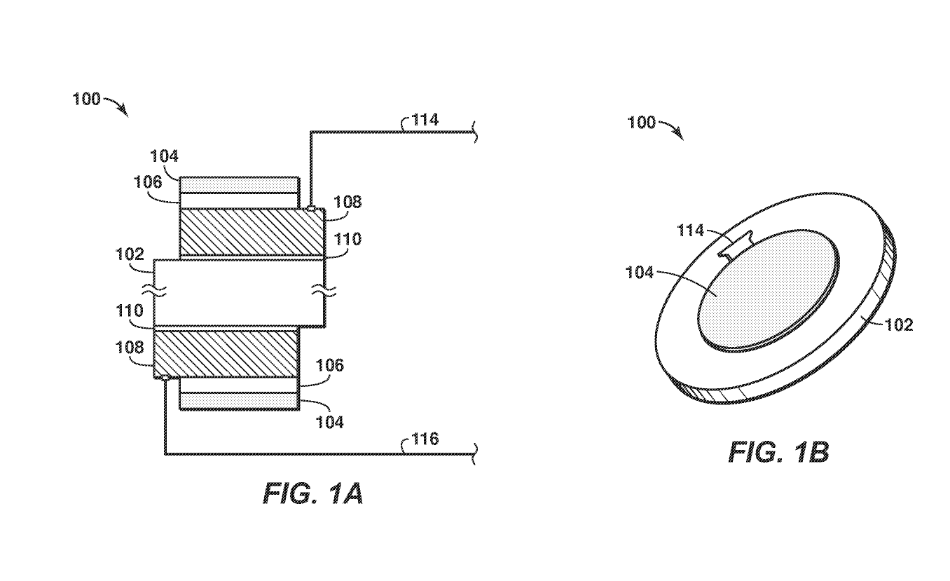

FIG. 1A is a schematic illustration of a QCM wafer 100 which can be packaged and/or placed within a mechanical system, for example, in an oil reservoir or sump of a mechanical system (not shown), in an oil delivery manifold or bypass manifold of a mechanical system (also not shown), or other system requiring lubrication or use of a working fluid where monitoring is desirable. As shown in FIG. 1, the QCM wafer 100 has a quartz crystal 102 positioned between similarly constructed outer layer films having a first face or sensitive layer 104, e.g., an about 10 to about 40 nanometer (nm) gold (Au) film, a barrier layer 106, e.g. an about 20 nm silicon dioxide (SiO₂) film, an electrode layer 108, e.g., an Au film of about 150 nm, and an adhesion layer 110, e.g., an about 10 nm titanium (Ti) film. As will be understood, the conducting element of the QCM wafer 100 can optionally be made of any suitable conducting material, such as a metal (e.g., gold, silver, platinum or palladium) or a conducting polymer (e.g., polypyrrole or polythiophene, or polyaniline) based on customary design criteria.

Electrodes 114 and 116 are electrically coupled to the electrode layer 108 on a first end and an analysis apparatus (not depicted) on a second end. Electrodes 114 and 116 may be used to apply a sinusoidal waveform across the quartz crystal 102 to create a measurable output that can be analyzed. This construction is selected from a plurality of known constructions for ease of demonstration and not by way of limitation; other constructions will be readily apparent to those of skill in the art and are considered within the scope of the present disclosure.

FIG. 1B is a perspective view of the QCM wafer 100. The components of FIG. 1B the same as the components of FIG. 1A. FIG. 1B shows one side or face of the QCM wafer 100 having a sensitive layer 104 and electrodes 114 and 116. The embodiment of FIG. 1B has a sensitive layer 104 with a diameter of about 4.5 millimeters (mm) and the QCM wafer 100 with a diameter of about 7.5 mm. The second face of the QCM wafer 100 may be similarly configured.

QCMs generally rely on the piezoelectric properties of quartz, in particular a single crystal of quartz, e.g., quartz crystal 102, that has been cut into a thin wafer at an angle, e.g., an angle of about 35 degrees with respect to the polar z-axis of quartz. AT-cut quartz crystal has near-zero frequency drift with temperature around room temperature, making it preferable for certain applications. Other such QCM implementations are well known to those of skill in the art and may be desired in other contexts. QCMs may be used to measure the mass of thin deposits that have adhered to its surface. The electrodes, e.g., electrodes 114 and 116, may be used to establish an electric field across the crystal. The crystal can be made to oscillate at its resonant frequency using a sinusoidal and/or alternating electric field and appropriate electronics. Most crystals of current interest resonate between about 5 to about 30 megahertz (MHz). The measured frequency is dependent, at least in part, upon the combined thickness of the quartz wafer, metal electrodes, and material deposited on the quartz crystal microbalance surface. Changes in frequency will result from mass changes occurring at the QCM surface result in known frequency changes, e.g., according to the Sauerbrey equation. High precision frequency measurements allow the detection of minute amounts of deposited material, e.g., as small as 100 picograms on a square centimeter, as understood by those of skill in the relevant art. Further, while the depicted QCM wafer 100 is circular, a variety of surface geometries are available and may be used within the scope of this disclosure. For example, the selective substrate film may be planar, spherical, concave, convex, and textured. The surface geometries of the substrate are generally planar and may be comprised of any two-dimensional shape. The planar substrates can optionally be continuous or micropatterned upon the underlying gold or conducting material surface using existing micropatterning technology. For example, binding sites may be placed on the surface of the QCM wafer in such a way to produce a micropatterned support that contains a large number of separate coated areas. Micropatterning the surface may be desired to provide selective adhesion on specific regions of the micropatterned surface. These and similar construction techniques will be apparent to those of skill in the art and are within the scope of this disclosure.

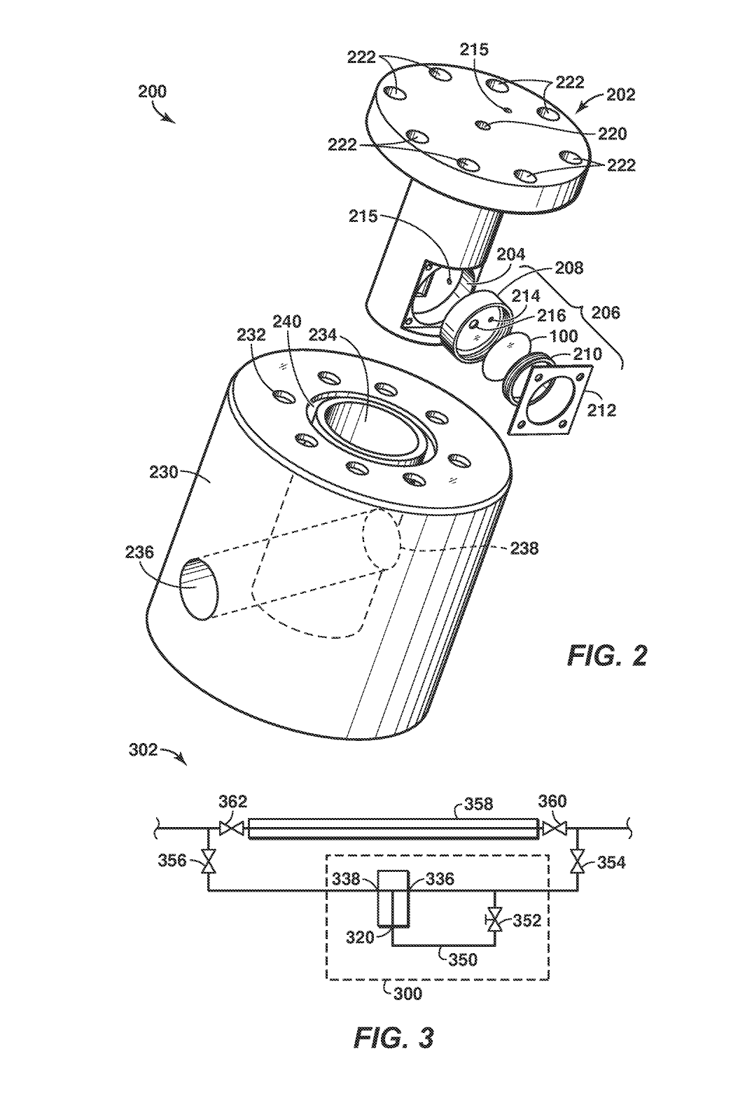

FIG. 2 is an exploded perspective view of a QCM sensor system 200. The QCM sensor system 200 comprises a QCM insert 202 having a first opening or QCM mounting recess 204 for receiving a QCM mounting assembly 206. QCM mounting assembly 206 comprises a QCM mounting structure 208, a QCM wafer 100, which may be the same as the QCM wafer 100 of FIGS. 1A and 1B, a QCM sealing assembly 210, and a second opening or QCM exposure window 212 configured to fixably couple to the QCM insert 202, e.g., using screws, bolts, glue, or other equivalent fixing structures. The QCM mounting structure 208 has an electrical wiring port 214 to accommodate passing an electrical connection and/or electrical lead (not depicted) therethrough to electrically couples electrodes 114 and 116 to an analysis apparatus (not depicted), e.g., an impedance frequency analyzer, etc., via wiring port 215. Other embodiments within the scope of this disclosure may utilize direct-butt coupling, terminal-based systems, or other wiring connections as known in the art. The QCM mounting structure 208 is constructed so as to create a barrier fluid chamber bounded by the QCM mounting structure 208 and the QCM wafer 100. The QCM mounting structure 208 has a barrier fluid port 216 for admitting a barrier fluid into the barrier fluid chamber. The barrier fluid chamber may be pressure sealed to prevent fluid communication between the barrier fluid chamber and the working fluid chamber. The QCM insert 202 comprises a barrier fluid port 220 in fluid communication with the barrier fluid chamber via barrier fluid port 216. The QCM insert 202 has mounting holes 222, described further below.

The QCM wafer 100 is positioned in the QCM mounting assembly 206 so as to position a sensing surface of the QCM wafer 100 facing the QCM exposure window 212 and a non-sensing surface of the QCM wafer 100 facing the QCM mounting structure 208. The non-sensing surface has electrodes, e.g., electrodes 114 and 116, facing the barrier fluid chamber. The placement and/or dimension of the electrodes 114 and 116 may depend on their positioning within the mechanical system and the nature of the working fluid being analyzed. The sensing surface is configured for exposure to a working fluid (not depicted) via the QCM exposure window 212. QCM sealing assembly 210 may comprise one or more O-rings, seals, gaskets, etc. to sealably couple the QCM exposure window 212 and the QCM wafer 100 isolating the barrier fluid chamber from exposure to the working fluid and/or keeping the QCM wafer 100 in place.

FIG. 2 further shows a QCM sensor housing 230 having a working fluid inlet 236, a working fluid outlet 238, and an annulus 234 for receiving the QCM insert 202 and mounting holes 232. Mounting holes 232 may be coupled to mounting holes 222, e.g., using screws, bolts, or other equivalent fixing structures. When the QCM insert 202 is received in the annulus 234, a working fluid chamber is bounded by the annulus 234, the QCM insert 202, the working fluid inlet 236, and the working fluid outlet 238. As shown, the mounting holes 232 and 222 may be aligned at a plurality of angles, thereby accommodating receipt of the QCM mounting insert 202 in the annulus 234 at a plurality of sensitive layer incidence with respect to the direction of flow in the working fluid chamber. For example, the direction of flow in the working fluid chamber may be along the sensitive layer. In some embodiments, this may extend in the same general direction as from the working fluid inlet 236 to the working fluid outlet 238. Other embodiments may redirect flow in the flow in the working fluid chamber such that the direction of flow may not be in the same general direction as from the working fluid inlet 236 to the working fluid outlet 238, e.g., a tumultuous and/or circular flow path, but may nonetheless be at an about zero incidence angle with respect to the sensitive layer. These and similar embodiments are within the scope of the present disclosure. The QCM sensor housing 230 may further comprise a sealing assembly 240 comprising one or more O-rings, seals, gaskets, etc. for sealably coupling the QCM insert 202 and the QCM sensor housing 230.

Other embodiments of the QCM sensor system 200 may be constructed so as to dispose the QCM mounting recess 204 and QCM mounting assembly 206 on the lower end of the QCM insert 202. Such embodiments may be referred to as bottom-facing QCM sensor systems as opposed to the side-facing QCM sensor system 200 illustrated in FIG. 2. Such embodiments may be placed in service in a variety of ways, as would be apparent to those of skill in the art. For example, a flow diverter may optionally be utilized in the lower end of the annulus 234 to orient the flow of the working fluid across the sensing face of QCM wafer 100.

Still other embodiments of the QCM sensor system 200 may be constructed so as to utilize a plurality of QCM wafers (e.g., 2, 3, 4, or more) mounted in a variety of optionally selected orientations on the QCM insert 202. For example, two QCM wafers may be disposed on the same side of a QCM insert 202 so as to provide redundancy, for calibration purposes, for error monitoring, etc. In other embodiments, a plurality of QCM wafers may be disposed on opposing sides of the QCM insert 202. In still other embodiments, bottom-facing and side-facing QCM sensor designs may be employed on a single QCM insert 202.

FIG. 3 is a line diagram of a QCM sensor system 300 positioned in an example working fluid system 302. The components of QCM sensor 300 may be substantially similar to the equivalent components of QCM sensor 200. For example, QCM sensor 300 has a working fluid inlet 336 corresponding to the working fluid inlet 236 of FIG. 2, a working fluid outlet 338 corresponding to the working fluid outlet 238 of FIG. 2, and a barrier fluid port 320 corresponding to the barrier fluid port 220 of FIG. 2. The QCM sensor 300 further comprises a pressure leg 350 coupled to the barrier fluid port 320 and having an isolation valve 352. The pressure leg 350 may contain a barrier fluid separate from the working fluid of the working fluid system 302, e.g., using a liquid-liquid interface. In some embodiments, the pressure leg 350 utilizes a mechanical separation device (not depicted), e.g., a piston, a diaphragm, etc., between the barrier fluid and the working fluid, and wherein the mechanical separation device is configured to transmit pressure from the working fluid to the barrier fluid. In some embodiments, the pressure leg 350 comprises a coiled tube or other nonlinear flowpath, e.g., for ensuring a sufficient volume of barrier fluid is present to prevent working fluid from entering the barrier fluid chamber and/or for ensuring barrier fluid remains present in the barrier fluid chamber in the event of a leak upstream of the barrier fluid port 320. Isolation valve 352 may be used to isolate the pressure leg 350 from the working fluid system 302. The working fluid system 302 further comprises isolation valves 354 and 356 for isolating the QCM sensor system 300. The working fluid system 302 optionally comprises a deposition tube 358 having isolation valves 360 and 362. As will be understood by those of skill in the art, FIG. 3 is illustrative and the working fluid system 302 may comprise any number of additional or alternate components, e.g., chemical addition tanks, recirculation pumps, clamp-on flow meters, heat recovery steam generators, etc.

Operation of the assembled QCM sensor system 300 may begin with placing the QCM sensor system 300 in service in the working fluid system 302. Such a technique may begin with filling a barrier fluid chamber or the electrical side of the QCM, e.g., at the QCM mounting assembly 206 (including the barrier fluid chamber) of FIG. 2, with barrier fluid using the barrier fluid port 320. The barrier fluid may be pumped into the QCM sensor system 300 until no further air bubbles are observed leaving the pressure leg 350, e.g., at isolation valve 352. Next, barrier fluid may be exposed to working fluid pressure by placing the barrier fluid in pressure leg 350 in fluid communication with the working fluid in working fluid system 302. Consequently, pressure changes in the working fluid will be transmitted to the barrier fluid, thereby maintaining a substantially constant and/or near-zero pressure differential across the QCM wafer, e.g., the QCM wafer 100 of FIG. 1. As described above, other embodiments may utilize a diaphragm design, a piston design, or other to ensure separation of the working fluid and the barrier fluid while still permitting pressure to be transmitted across the boundary; such other embodiments are within the scope of the present disclosure.

Thus, the QCM sensor system 300 is suitably employed in conjunction with working fluid systems at high and ultra-high pressures. For example, because the differential pressure across the QCM wafer is substantially constant zero or near-zero pressure, the QCM sensor system 300 is compatible with a variety of working fluid systems, e.g., working fluid systems having a pressure of at least 100 psia (689.4×10⁵ pascal (Pa)), at least 1,000 psia (689.4×10⁶ Pa), at least 10,000 psia (689.4×10⁷ Pa), and/or at least 20,000 psia (120.7×10⁸ Pa). As pressure will be transmitted to the barrier fluid during operation, the barrier fluid port 320, and thus the QCM sensor system 300 as a whole, may be configured to receive barrier fluid at a pressure of at least 100 psia, at least 1,000 psia, at least 10,000 psia, and/or at least 20,000 psia. Consequently, pressure ranges suitable for using the above techniques may include 100-50,000 psia, 1,000-50,000 psia, 10,000-50,000 psia, 20,000-50,000 psia, 100-20,000 psia, 1,000-20,000 psia, and/or 10,000-20,000 psia. Similarly, it will be understood that the QCM sensor system 300, and particularly the working fluid chamber, is compatible with a variety of working fluid temperatures, e.g., working fluid systems having temperatures between −40° Celsius (C) and 300° C. The suitability of these and other variations of pressure and temperature, including extrapolated ranges and interpolated ranges, will be apparent to those of skill in the art.

While the present techniques may be susceptible to various modifications and alternative forms, the exemplary embodiments discussed herein have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

1. A quartz crystal microbalance (QCM) sensor apparatus comprising:
a QCM mounting insert having a first opening, a second opening, and a barrier fluid chamber disposed between the first opening and the second opening; and
a QCM wafer sealably coupled to the second opening, wherein the QCM wafer has an electrode contact exposed to the barrier fluid chamber and a sensitive layer that is not exposed to the barrier fluid chamber.

2. The QCM sensor apparatus of claim 1, further comprising a QCM sensor housing, wherein the QCM sensor housing comprises:
an annulus configured to receive the QCM mounting insert;
a working fluid inlet;
a working fluid outlet; and
a working fluid chamber,
wherein at least part of the sensitive layer is exposed to the working fluid chamber when the QCM mounting insert is received in the annulus of the QCM sensor housing.

3. The QCM sensor apparatus of claim 2, wherein the QCM sensor housing is configured to receive the QCM mounting insert in the annulus such that a direction of flow in the working fluid chamber is along the sensitive layer.

4. The QCM sensor apparatus of claim 3, wherein the QCM sensor housing is configured to fixably receive the QCM mounting insert in the annulus at a plurality of sensitive layer incidence angles with respect to the direction of flow in the working fluid chamber from the working fluid inlet to the working fluid outlet.

5. The QCM sensor apparatus of claim 2, wherein the working fluid chamber is configured to receive working fluid at a temperature between −40° Celsius (C) and 300° C.

6. The QCM sensor apparatus of claim 1, wherein the QCM mounting insert further comprises an opening suitable to passably dispose an electrical connection to the QCM wafer.

7. The QCM sensor apparatus of claim 1, wherein the second opening comprises a sealing assembly for sealably coupling the QCM wafer to the second opening, and wherein the sealing assembly comprises an o-ring.

8. The QCM sensor apparatus of claim 1, wherein the QCM mounting insert further comprises a barrier fluid port configured to receive barrier fluid.

9. The QCM sensor apparatus of claim 8, wherein the barrier fluid port is further configured to receive barrier fluid at a pressure of at least 100 pounds per square inch absolute (psia) (689.4×10⁵ pascal (Pa)).

10. The QCM sensor apparatus of claim 9, wherein the barrier fluid port is further configured to receive barrier fluid at a pressure of at least 10,000 psia (689.4×10⁷ Pa).

11. A quartz crystal microbalance (QCM) sensor system comprising:
a QCM mounting insert comprising:
a first opening;
a second opening;
a barrier fluid chamber disposed between the first opening and the second opening; and
a barrier fluid port configured to receive a barrier fluid and direct the barrier fluid to the barrier fluid chamber;
a QCM wafer sealably coupled to the second opening of the QCM mounting insert, comprising:
a sensitive layer on a first face; and
an electrode contact layer on a second face;
a QCM sensor housing comprising:
an annulus configured to receive the QCM mounting insert;
a working fluid inlet;
a working fluid outlet; and
a working fluid chamber; and
a pressure leg coupled to the barrier fluid port and configured to transfer a pressure to the barrier fluid chamber, wherein the QCM mounting insert is configured to expose at least part of the first face of the QCM wafer to the working fluid chamber and expose at least part of the second face of the QCM wafer to the barrier fluid chamber when the QCM mounting insert is received in the annulus of the QCM sensor housing.

12. The QCM sensor system of claim 11, wherein the pressure leg comprises a coiled tube.

13. The QCM sensor system of claim 11, wherein the pressure leg comprises a barrier fluid in communication with a working fluid.

14. The QCM sensor of claim 11, wherein the pressure leg comprises an isolation valve for preventing the transmission of pressure from the working fluid to the barrier fluid.

15. The QCM sensor of claim 11, wherein the pressure leg comprises a mechanical separation device between a barrier fluid and a working fluid, and wherein the mechanical separation device is configured to transmit pressure from the working fluid to the barrier fluid.

16. The QCM sensor of claim 11, wherein the QCM sensor housing is configured to fixably receive the QCM mounting insert in the annulus such that a direction of flow in the working fluid chamber is along the sensitive layer.

17. The QCM sensor of claim 11, wherein the QCM sensor housing is configured to fixably receive the QCM mounting insert in the annulus at one of a plurality of sensitive layer incidence angles with respect to the direction of flow in the working fluid chamber from the working fluid inlet to the working fluid outlet.

18. A method of measuring a deposit on a quartz crystal microbalance (QCM) sensor, comprising:
placing in service an apparatus comprising a QCM wafer coupled to a QCM mounting insert, wherein the QCM mounting insert comprises a first opening, a second opening, and a barrier fluid chamber positioned between the first opening and the second opening, wherein the QCM wafer has a first face having a sensitive layer and a second face having an electrode contact, wherein the QCM wafer is sealably coupled to the second opening such that at least part of the second face is exposed to the barrier fluid chamber, and wherein the QCM mounting insert is received in an annulus of a QCM housing, wherein the QCM housing comprises:
a working fluid inlet;
a working fluid outlet; and
a working fluid chamber;
applying a first pressure on the first face of the QCM wafer using a barrier fluid and applying a second pressure on the second face of the QCM wafer using a working fluid, wherein the first pressure and the second pressure are substantially equal;
flowing the working fluid from the working fluid inlet to the working fluid outlet such that the working fluid is passed across the first face of the QCM wafer in the working fluid chamber, wherein flowing the working fluid deposits a substance on the first face of the QCM wafer;
substantially stopping the flow of the working fluid across the first face of the QCM wafer in the working fluid chamber; and
measuring a resonance frequency of the QCM wafer.

19. The method of claim 18, wherein disposing the QCM mounting insert in the annulus of the QCM housing comprises:
fixably coupling the QCM mounting insert in the annulus of the QCM housing at an incidence angle with respect to the flow in the working fluid chamber.

20. The method of claim 18, wherein the working fluid is a hydrocarbon.

21. The method of claim 18, wherein the QCM mounting insert comprises a barrier fluid port configured to receive barrier fluid, further comprising pressurizing the barrier fluid to the first pressure at an interface using the working fluid.

22. The method of claim 21, wherein the interface is selected from a group consisting of: a piston, a diaphragm, and a liquid-liquid interface.

23. The use of an apparatus of claims 1-9 or a system according to claims 11-17 for measuring a deposit on a quartz crystal microbalance (QCM) sensor for a fluid having greater than 100 pounds per square inch absolute (psia) (689.4×10⁵ pascal (Pa)).
